(19) United States
(12) Patent Application Publication
(10) Pub. No.: US 2009/0262606 A1
(43) Pub. Date: Oct. 22, 2009

(54) Toothbrush Holder

(76) Inventor: Yechiel Trost, Hadera (IL)

Correspondence Address: William H. Dippert;Eckert Seamans Cherin & Mellott, LLC, U.S. Steel Tower, 600 Grant Street, 44th Floor, Pittsburgh, PA, 15219, US

(21) Appl. No.: 12/105,542

(22) Filed: Apr. 18, 2008

(51) Int. Cl. G04B 47/00; A46B 17/00

(52) U.S. Cl. 368/10; 248/110

(57) ABSTRACT

A toothbrush holder for holding toothbrush is provided that comprises a body having concaved depression for receiving the toothbrush, a sensor provided in the concaved depression, a display activated by the sensor for a predetermined time and a counter capable of receiving signal from the sensor and communicating with the display. When the toothbrush is removed from the depression, the sensor is operated to transmit a signal to the counter that in turn activates the display for a predetermined time. Further provided is a method of doing business that comprises exposing a user to a message of an entity each time the user brushes his teeth and charging the entity for exposing their message.

### FIELD OF THE INVENTION

The present invention relates to a toothbrush holder. More particularly, the present invention relates to a holder that automatically indicates a recommended time interval for the user to brush his teeth when he takes the toothbrush out of the holder.

### BACKGROUND OF THE INVENTION

Teeth brushing is a monotonic action that is handled manually or semi manually by using a toothbrush. According to dentists' recommendations, the action of brushing the teeth should take no less than two minutes in order to wash out the plaque and bacteria that might make the teeth more susceptible to tooth decay. Despite the dentists' recommendations, many people do not allocate the needed time for brushing their teeth.

There are several apparatii known in the art that use signaling techniques such as visual, vocal, motion, etc. in order to indicate when the recommended time has lapsed and by doing so, these apparatii nullify the need of using a clock or other device in order to monitor the brushing time interval.

One type of solutions is embedding a time sensor in the toothbrush. U.S. Pat. No. 6,606,755 by Robinson et al. filed in 2000 discloses a toothbrush having a light source for signaling when a recommended brushing time interval has started and ended. In particular, the toothbrush includes a handle portion having a translucent portion configured to allow the transmission of light therefrom around substantially the entire circumference of the toothbrush. The toothbrush further includes a tip portion attached to the handle portion having a plurality of bristles extending therefrom. The tip portion is detachable from the handle portion. The toothbrush further includes a light emitting diode disposed within the handle portion proximate to the translucent portion. Finally, the toothbrush includes a control circuit disposed within the handle portion electrically connected to the light emitting diode.

Another solution is offering a transferable device that is put on the toothbrush. U.S. Pat. No. 5,894,453 by Pond filed in 1998 discloses a toothbrush receptacle with timing device comprises a hollow body structure having a body opening at one end and a compartment provided adjacent to the other end for accommodating a timing device. The compartment has a compartment opening at the second end of the body structure. The toothbrush receptacle further comprises an exterior surface and an interior surface. The toothbrush receptacle may comprise a sleeve consisting of a resilient material, such as rubber or vinyl, positioned and bonded within the hollow body structure and adjacent to the interior surface of the body structure

Yet another solution is based on using a user adjusted timer. U.S. Pat. No. 6,345,015 by Coulson filed in 2000 discloses a tooth brushing timer apparatus disposed within a tooth-configured housing which presents a visual representation of the time elapsed for the brushing of teeth. Following activation, the user-adjustable timing indicator provides a visual display of the elapsing tooth brushing time, further providing an audible signal upon reaching the end point. In addition, the timer apparatus may stand alone or be movably mounted on a stationary support.

Yet another solution is based on the use of a sound producing device. U.S. Pat. No. 5,864,288 by Hogan filed in 1997 discloses a tooth brush holder adapted to contain at least one tooth brush and having therein means such that when the toothbrush is removed from the holder a sound producing device is actuated and can continue to produce sound for at least a predetermined time. If the toothbrush is replaced in the holder before the predetermined time period has elapsed, a warning message may be activated advising the user that more brushing is needed. If the toothbrush is replaced after the predetermined time period has elapsed (and/or message has been played), a reward may be generated.

There are disadvantages in using these solutions for monitoring and indicating the time for brushing teeth. First, solutions based on embedment of a timer in the toothbrush itself require an independent timer for each toothbrush. Second, solutions based on intentional activation of the timer by the user before starting the brushing action are not reliable enough since the user can decide whether he wishes to activate the system or not.

There is a need for a toothbrush holder capable of sensing toothbrush removal from the apparatus it is stationed in, visually indicating the progress of the brushing process and utilizing the illumination device for additional purposes such as advertising specific concepts or products.

### SUMMARY OF THE INVENTION

It is an object of the present invention to provide a new and unique toothbrush holder automatically activating time counter indicating a predetermined time interval recommended for brushing teeth.

Another object of the present invention is to provide an automatic and non mechanical mechanism for activating the time counter that is embedded in the toothbrush holder.

It is another object of the present invention to provide a toothbrush holder providing count down of a predetermined time interval while a display indicator is evolving into a complete message when time is lapsed.

It is yet another object of the present invention to provide a method of doing business in which each time a user removes the toothbrush from its holder he is exposed to a commercial message or a slogan or a brand name of a commercial entity, preferably connected with tooth brushing.

It is therefore provided in accordance with a preferred embodiment of the present invention a toothbrush holder for holding at least one toothbrush comprising:

a body having at least one concaved depression for receiving the toothbrush;

a sensor provided in said at least one concaved depression;

a display activated by said sensor for a predetermined time;

a counter capable of receiving signal from the sensor and communicating with said display;

whereby when the toothbrush is removed from the depression, the sensor is operated to transmit a signal to said counter that in turn activate said display for a predetermined time.

Furthermore and in accordance with another preferred embodiment of the present invention, said sensor is a light sensor.

Furthermore and in accordance with another preferred embodiment of the present invention, said depression is provided with a ridge-shaped edge.

Furthermore and in accordance with another preferred embodiment of the present invention, said depression is designed to direct the toothbrush to a certain position on said edge beneath which said at least one light sensor is positioned.

Furthermore and in accordance with another preferred embodiment of the present invention, said display is a LED display.

Furthermore and in accordance with another preferred embodiment of the present invention, said display is provided on an outer side of said body.

Furthermore and in accordance with another preferred embodiment of the present invention, said display is evolving during a countdown of said counter.

Furthermore and in accordance with another preferred embodiment of the present invention, said display represents a slogan.

Furthermore and in accordance with another preferred embodiment of the present invention, said slogan is selected from a group of slogan such as educational or commercial slogan.

Furthermore and in accordance with another preferred embodiment of the present invention, a hole is provided in said depression so as to allow drainage.

Furthermore and in accordance with another preferred embodiment of the present invention, a power source is provided in said body.

In accordance with another aspect of the present invention, a method of doing business is provided wherein the method comprises exposing a user to a commercial each time the user brushes his teeth.

Furthermore and in accordance with another preferred embodiment of the present invention, said commercial is activated upon removal of a toothbrush from a holder.

Furthermore and in accordance with another preferred embodiment of the present invention, said commercial is displayed on a surface of said holder.

Furthermore and in accordance with another preferred embodiment of the present invention, said commercial is evolving during a predetermined time in which the user brushes his teeth.

In accordance with yet another preferred embodiment of the present invention, a method of doing business is provided to comprise:

providing a toothbrush holder comprising:

a body having at least one concaved depression for receiving the toothbrush;

a sensor provided in said at least one concaved depression wherein said sensor is capable of sensing removal of the toothbrush from the holder;

a counter capable of receiving signal from said at least one sensor;

providing a display on the holder, wherein said display represents a commercial message and wherein said display is activated by the sensor.

Furthermore and in accordance with another preferred embodiment of the present invention, a method of doing business comprising:

exposing a user to a message of an entity each time the user brushes his teeth;

charging said entity for exposing said message.

Furthermore and in accordance with another preferred embodiment of the present invention, said message is a brand name or a slogan.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a toothbrush holder in accordance with a preferred embodiment of the present invention.

FIG. 2 illustrates side view of the holder shown in FIG. 1.

FIG. 3 illustrates a top view of the holder shown in FIG. 1.

FIG. 4 illustrates cross sectional view of the holder shown in FIG. 1.

FIG. 5 illustrates a bottom view of the holder shown in FIG. 1.

### DETAILED DESCRIPTION OF THE INVENTION AND FIGURES

The present invention provides a new and unique toothbrush holder that facilitates the user to keep track of time required to brush his teeth. In accordance with one aspect of the present invention, the holder automatically initiates count down of time when the user removes the toothbrush from the holder.

In accordance with another preferred embodiment of the present invention, the user brushes his teeth as long as the countdown is operated and the countdown is represented by a set of LEDs that are continuously evolving as long as the time has not lapsed.

In accordance with yet another aspect of the present invention, the LED representation can be used in order to expose the user to a commercial message on a daily bases, for a predetermined time.

In accordance with the present invention, a toothbrush holder is provided for holding at least one toothbrush. The holder comprises a body having a cup-shaped depression for receiving the toothbrush, and at least one light sensor provided in the depression. A display is activated by the sensor for a predetermined time, which is the time needed for teeth brushing. It is further provided a counter capable of receiving signal from the light sensor and communicating with the display. When the toothbrush is removed from the depression, the light sensor senses light and transmit a signal to the counter that in turn activates the display for a predetermined time.

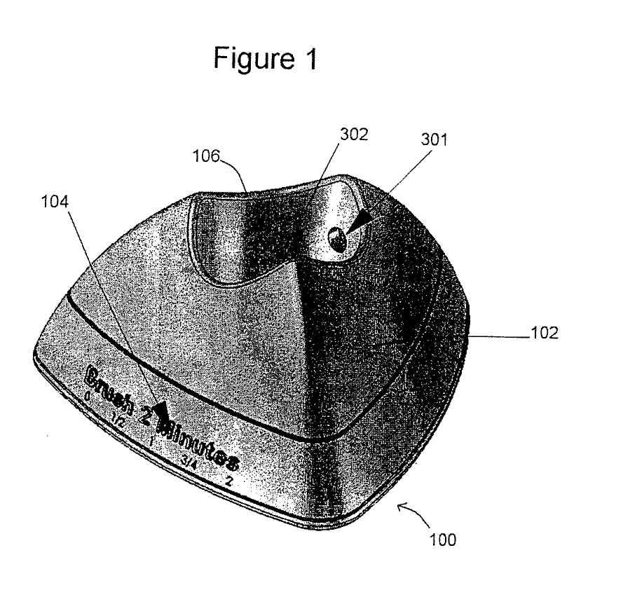

Reference is now made to FIG. 1 illustrating the toothbrush holder in accordance with a preferred embodiment of the present invention. A holder 100 compise of a body 102 that is capable of receiving and holding a toothbrush inside a depression 302. Depression 302 is sized to hold a regular toothbrush as well as electronic toothbrush having larger dimensions or a very thin one. Body 102 can be firmly stationed on a surface. Body 102 can be designed in any shape; however, three faces are preferably provided on the outer surface of the body. Each of the holder faces may contain a message zone 104 for indicating the time interval in which the user should brush his teeth. The messages in message zone 104 are preferably displayed using LED illumination elements. For example, holder 100 may provide countdown of a predetermined time interval while a display indicator is evolving into a complete message when time is lapsed. The toothbrush is placed inside body 102 and is leaning on an edge 106 of the holder. Since the use of the toothbrush is done near a water source, holder 100 and its parts are fully water resistant. When the user removes the toothbrush from the holder, he automatically activates a mechanism of countdown that is represented by the LED. The LED indicates how much time the user has to brush his teeth and/or how much time the user already brushed his teeth and how much time he still has to brush.

The toothbrush holder of the present invention has an educational feature by which the user is being trained to brush his teeth for a predetermined time that is now determined by dentist's to be two minutes. However, any other time that is recommended is applicable to the device of the present invention.

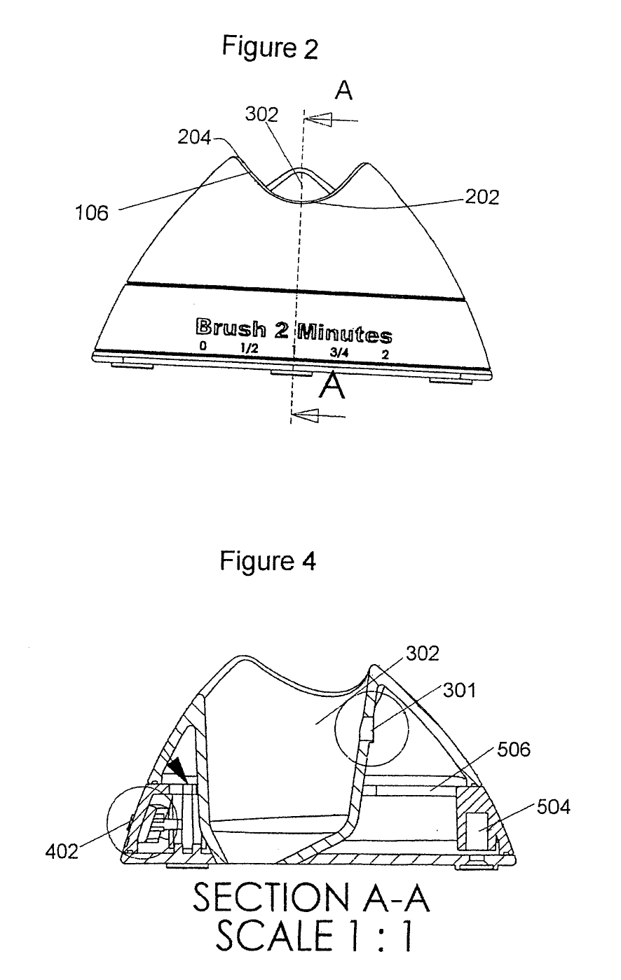

Reference is now made to FIG. 2 illustrating side view of the holder shown in FIG. 1. In the side view, one can observe that depression 302 is provided with an upper edge 106 ridge-shaped. Edge 106 has peaks 204 and dips 202.

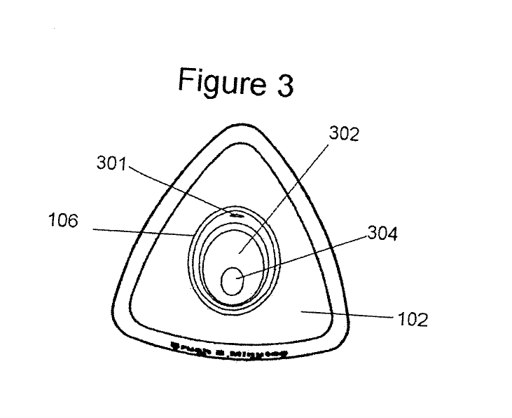

Reference is now made to FIG. 3 illustrating a top view of the toothbrush holder shown in FIG. 1. The top view of the holder clearly illustrates depression 302 that is designated to uphold toothbrush (the toothbrush is not shown in the figures). As described herein before, the toothbrush is naturally leaned over dips 202 of edge 106 and therefore tends to stay stable and does not move. A sensor 301 is provided in depression 302 wherein sensor 301 is designated to sense any change in the positioning of the toothbrush in the holder. When the toothbrush is removed from holder 100, sensor 301 is sensing that the brush is removed and the brushing action is being started. A time counter is automatically activated. The time counter embedded in holder 100 is operated so as to assure that the total brushing time will not be lessen than two minutes (or any other predetermined time period) while taking in account overhead time that consist of removing the toothbrush and getting it back as well as smearing a paste on the toothbrush. During the total brushing time, a unique message is preferably displayed in the message zone 104.

Sensor 301 might be triggered using several techniques and there are many forms of switching devices that may be utilized. In the preferred embodiment of the present invention, the sensor used is a light sensor placed in depression 302. The use of light sensor that is disclosed in this disclosure does not limit the use of other optical or electronic sensors that can be used in the disclosed device. As mentioned herein before, the depression is designed to have a ridge shaped edge so as to direct the toothbrush to lean against dips 202. Therefore, when a toothbrush is removed from the holder, light enters the depression and the sensor is activated so as to start the countdown of time. The ridge of edge 106 of depression 302 is designed so as to direct the toothbrush to one specific dip below which sensor 301 is provided. In this way, the sensor is more effective.

It is preferable to position the sensor at 50 degrees relative to the base of the holder's body so as to achieve maximal effectiveness of light coverage when the toothbrush is leaned against the depression's wall.

Optionally and although a single sensor is described, more than one sensor can be embedded within the inner surface of the depression.

It should be mentioned herein that several depressions can be used in a single holder so as to be able to position several toothbrushes. Each depression is provided with a sensor and is receiving a single toothbrush. Each sensor is preferably connected to its own set of LED that indicate the time lapse. This option can be used without limiting the scope of the present invention.

It should be mentioned that a light sensor is preferable in such a device since it is electronic and doesn't bear any mechanical features that tend to fail especially when the environment is humid or when children are involved.

The bottom of depression 302 is provided with a draining hole 304 adapted to drain the depression from excess water.

Reference is now made to FIG. 4 illustrating side cross sectional view of the holder shown in FIG. 1. It can be shown that depression 302 is concaved and is fastened to the body of the holder with several joints 504 and construction tunnels 506. A series of LEDS 402 is provided in the message zone in the front of the holder. Sensor 301 is connected to LED 402 by LED illumination wires that can be transferred through construction tunnels 506 so as to electrically connect both sensor and LED as well as both of them to a power source (not shown in this figure). FIG. 4 illustrates clearly the uneven shape of depression 302 that is shaped so as to impose the toothbrush to lean on the edge of the depression on top of sensor 301.

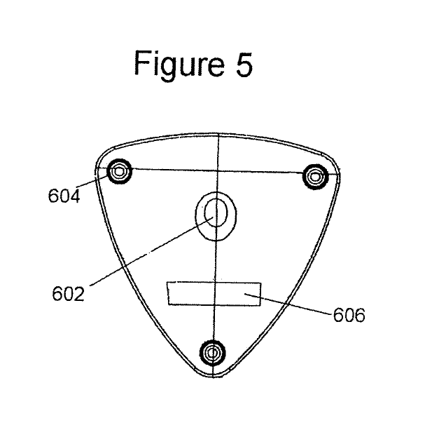

Reference is now made to FIG. 5 illustrating a bottom view of the holder shown in FIG. 1. The bottom of depression 302 is provided with a hole 304 substantially in the middle of a bottom plane 602. Risers 604 are located on the bottom plane 602 of holder 100 so as to stabilize the holder when placed on a surface.

In addition, risers 604 are used to protect the bottom of the holder from wear and exhaustion.

The electronic parts of the holder are operated using a power source. Preferably, the power source resides in the bottom part of the holder in a dedicated chamber 606.

The LED representation can be a timer or a shape that is evolved with time to a full image when the brushing time elapses. The representation can be presented as a shape without any meaning; however, a meaningful shape is preferable. A meaningful presentation can be of an educational nature such as “brush 2 minutes” as shown in FIG. 1 as an example. Any other slogan can be used without limiting the scope of the present invention. An educational slogan is especially preferably when children are using the holder so as to train them to brush their teeth for at least two minutes.

The fact that the user of the holder is using the holder at least twice a day, one can provide a slogan that is commercial. It is provided in accordance with a preferred embodiment of the present invention a business method in which a commercial slogan is evolved when countdown proceeds. The manufacturer of the toothbrush holder can receive additional fees from companies or other entities that may want their name, logo, trademark, brand name, slogan etc. to be displayed on the holder. This is especially beneficial for toothpaste companies, as an example. The commercial entity is charged for each holder that is being bought due to the exposure of their slogan or brand name to the user every time he brushes his teeth. The device can be activated automatically or using an activation button.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A toothbrush holder for holding at least one toothbrush comprising:
a body having at least one concaved depression for receiving one toothbrush;
a sensor provided in said at least one concaved depression;
a display activated by said sensor for a predetermined time;
a counter capable of receiving signal from the sensor and communicating with said display;
whereby when the toothbrush is removed from the depression, the sensor is operated to transmit a signal to said counter that in turn activates said display for a predetermined time.

2. The holder as claimed in claim 1, wherein said sensor is a light sensor.

3. The holder as claimed in claim 1, wherein said depression is provided with a ridge-shaped edge.

4. The holder as claimed in claim 3, wherein said depression is designed to direct the toothbrush to a certain position on said edge beneath which said at least one light sensor is positioned.

5. The holder as claimed in claim 1, wherein said display is a LED display.

6. The holder as claimed in claim 1, wherein said display is provided on an outer side of said body.

7. The holder as claimed in claim 1, wherein said display is evolving during a countdown of said counter.

8. The holder as claimed in claim 1, wherein said display represents a slogan.

9. The holder as claimed in claim 8, wherein said slogan is selected from a group of slogan such as educational or commercial slogan.

10. The holder as claimed in claim 1, wherein a hole is provided in said depression so as to allow drainage.

11. The holder as claimed in claim 1, wherein a power source is provided in said body.

12. A method of doing business comprising exposing a user to a commercial each time the user brushes his teeth.

13. The method as claimed in claim 12, wherein said commercial is automatically activated upon removal of a toothbrush from a holder.

14. The method as claimed in claim 12, wherein said commercial is manually activated.

15. The method as claimed in claim 12, wherein said commercial is displays on a surface of said holder.

16. The method as claimed in claim 12, wherein said commercial is evolving during a predetermined time in which the user brushes his teeth.

17. A method of doing business comprising:
providing a toothbrush holder comprising:
a body having at least one concaved depression for receiving the toothbrush;
a sensor provided in said at least one concaved depression wherein said sensor is capable of sensing removal of the toothbrush from the holder;
a counter capable of receiving signal from said at least one sensor;
providing a display on the holder, wherein said display represents a commercial message and wherein said display is activated by the sensor.

18. A method of doing business comprising:
exposing a user to a message of an entity each time the user brushes his teeth;
charging said entity for exposing said message.

19. The method as claimed in claim 18, wherein said message is a brand name or a slogan.
